(19) United States
(12) Patent Application Publication
(10) Pub. No.: US 2002/0105954 A1
(43) Pub. Date: Aug. 8, 2002

(54) Dynamic update proxy

(76) Inventors: Peter Alan Craig, San Anselmo Marin, CA (US); Nia Brett Schmald, Berkeley, CA (US)

Correspondence Address: SAWYER LAW GROUP LLP, P.O. Box 51418, Palo Alto, CA, 94303, US

(21) Appl. No.: 09/776,400

(22) Filed: Feb. 2, 2001

(51) Int. Cl. H04L 12/28

(52) U.S. Cl. 370/401; 370/475

(57) ABSTRACT

The present invention provides a method and system for maintaining an address of a dynamically addressed router in a network. The system in accordance with the present invention includes a proxy residing at the Domain Name Server (DNS) and an update message generator residing at each server connected to the dynamically addressed router. The method in accordance with the present invention includes: creating an update message by an update message generator residing on the server, where a source address of the update message is an address of the server; translating the source address of the update message to a current address of the dynamically addressed router; sending the update message to a proxy residing on the DNS; and updating by the proxy an address of the dynamically addressed router stored in the DNS with the source address of the update message.

### FIELD OF THE INVENTION

The present invention relates to computer networks, and more particularly to the addressing of message transmitted in a computer network.

### BACKGROUND OF THE INVENTION

FIG. 1 illustrates a conventional computer network. The network includes servers 102 and 112, clients 104 and 114, and a Domain Name Server 106 (DNS). Assume that the different components in the network transmits messages to each other through the Internet via an Internet Protocol (IP). The DNS 106 stores and maintains the IP addresses of the components in the network. Server 112 and client 114 communicate through the Internet via a router 110. In most conventional networks, the IP address of the router 110 is static. However, the use of a dynamically addressed router 110 is beginning to be used in networks. The dynamically addressed router 110, such as a Network Address Translation router or NAT, has an IP address which periodically changes. The use of a dynamically addressed router 110 allows a service provider to reduce the costs to its customers for maintaining a web site since the cost of providing dynamic IP addresses is less than static IP addresses.

FIG. 2 illustrates the transmission of a message from a client connected to a dynamically addressed router in the conventional network. The client 114 creates a message 202 with a header which contains a source IP address and a destination IP address. The source IP address is the address of the component which is sending a message. The destination IP address is the address of the component which is the intended recipient of the message. The message contains other data, such as the host name 208 and the host address 210. In message 202, the IP address of the client 114 is the source IP address 204, and the IP address of the server 102 is the destination IP address 206. This message 202 is sent to the dynamically addressed router 110. The dynamically addressed router 110 then translates the client IP address 114 to its own IP address 210. The message 208 from the dynamically addressed router 110 is then sent to the destination, i.e., server 102. The translation of the source IP address by a dynamically addressed router is well known in the art and will not be further described here.

However, as illustrated in FIG. 3, there is problem when a message 302 is transmitted from a client 104 not connected to the dynamically addressed router 110 to a server 112 that is connected to the dynamically addressed router 110. When the client 104 creates the message 302, it uses its own IP address as the source IP address 304, and the IP address of the dynamically addressed router 110 as the destination IP address 306. However, if the IP address of the dynamically addressed router 110 has changed, then the message 302 is unable to reach the dynamically addressed router 110, which in turn prevents the message 302 from reaching the proper destination, i.e., server 112. Thus, in conventional networks, communication via a dynamically addressed router 110 may only be reliably accomplished between components which are both connected to the dynamically addressed router 110.

Accordingly, there exists a need for a method and system for maintaining a current address for a dynamically addressed router. The method and system should allow components not connected to the dynamically addressed router to reliably complete the transmission of messages to components connected to the dynamically addressed router. The present invention addresses such a need.

### SUMMARY OF THE INVENTION

The present invention provides a method and system for maintaining an address of a dynamically addressed router in a network. The system in accordance with the present invention includes a proxy residing at the Domain Name Server (DNS) and an update message generator residing at each server connected to the dynamically addressed router. The method in accordance with the present invention includes: creating an update message by an update message generator residing on the server, where a source address of the update message is an address of the server; translating the source address of the update message to a current address of the dynamically addressed router; sending the update message to a proxy residing on the DNS; and updating by the proxy an address of the dynamically addressed router stored in the DNS with the source address of the update message.

### BRIEF DESCRIPTION OF THE FIGURES

FIG. 1 illustrates a conventional computer network.

FIG. 2 illustrates the transmission of a message from a client connected to a dynamically addressed router in the conventional network.

FIG. 3 illustrates a program in the transmission of a message from a client not connected to a dynamically addressed router in the conventional network.

FIG. 4 illustrates a preferred embodiment of a system for maintaining an address for a dynamically addressed router in accordance with the present invention.

FIGS. 5 and 6, respectively, are a flow chart and a block diagram illustrating a preferred embodiment of a method for maintaining an address for a dynamically addressed router in accordance with the present invention.

FIGS. 7 and 8, respectively, are a flow chart and a block diagram illustrating an addressing of a message to a dynamically addressed router in accordance with the present invention.

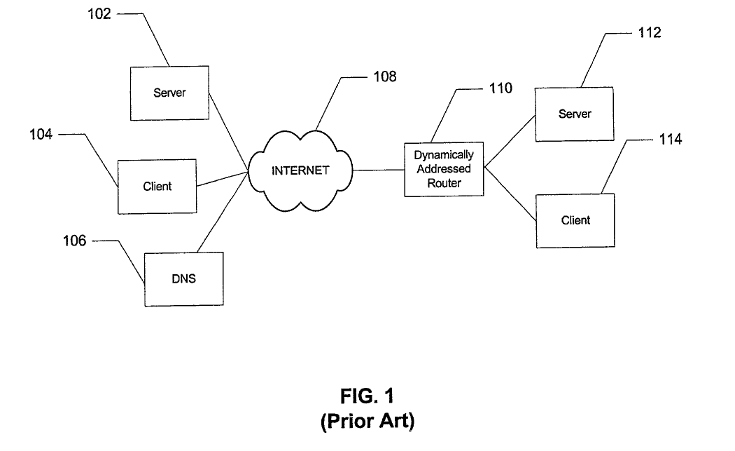

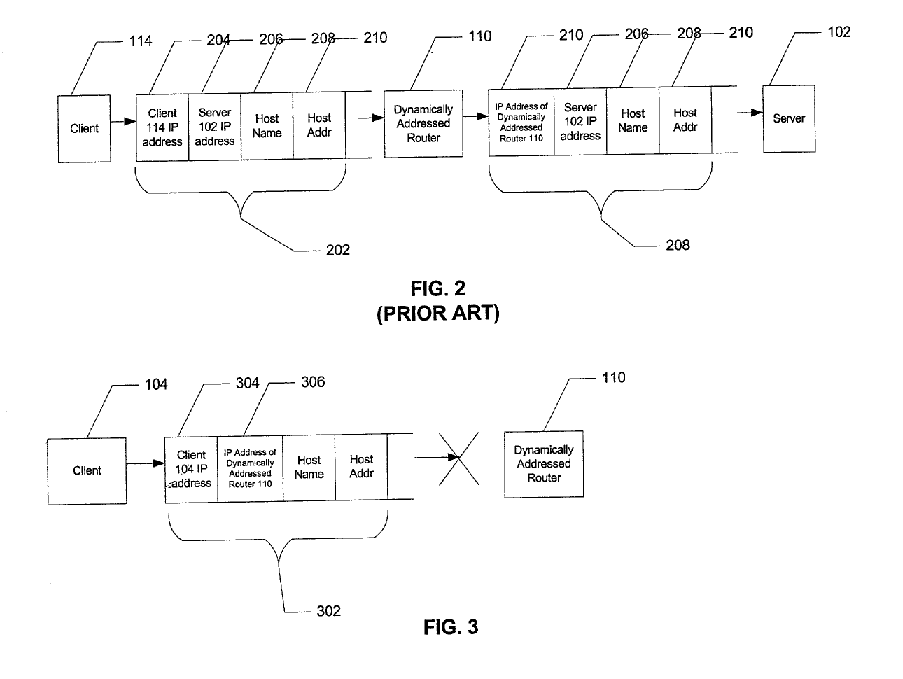

### DETAILED DESCRIPTION

The present invention provides a method and system for maintaining a current address for a dynamic address router. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The method and system in accordance with the present invention includes a proxy residing at the Domain Name Server (DNS) and an update message generator residing at each server connected to a dynamically addressed router. At certain intervals, and/or when the address of the dynamically addressed router is changed, the update message generator sends an update message to the proxy. The update message contains the current address of the dynamically addressed router as its source address. The proxy updates the address of the dynamically addressed router stored on the DNS with the source address of the update message.

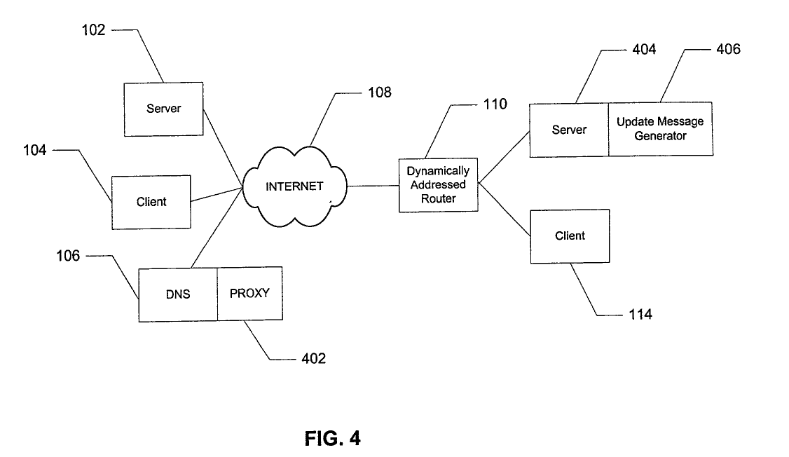

To more particularly describe the features of the present invention, please refer to FIGS. 4 through 8 in conjunction with the discussion below.

FIG. 4 illustrates a preferred embodiment of a system for maintaining an address for a dynamically addressed router in accordance with the present invention. The system includes a proxy 402 residing at the DNS 106 and an update message generator 406 on each server 404 connected to a dynamically addressed router 110. In the preferred embodiment, the proxy 402 and the update message generator 406 are implemented in software. The server 404 need not be a name server.

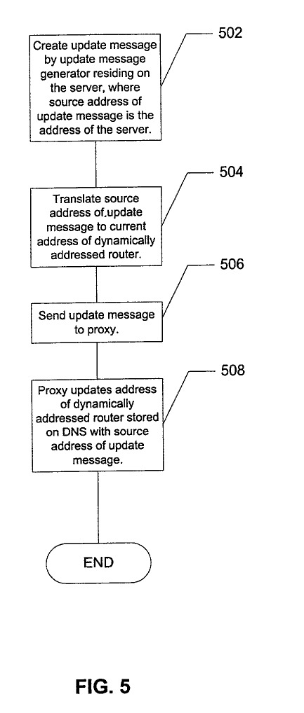

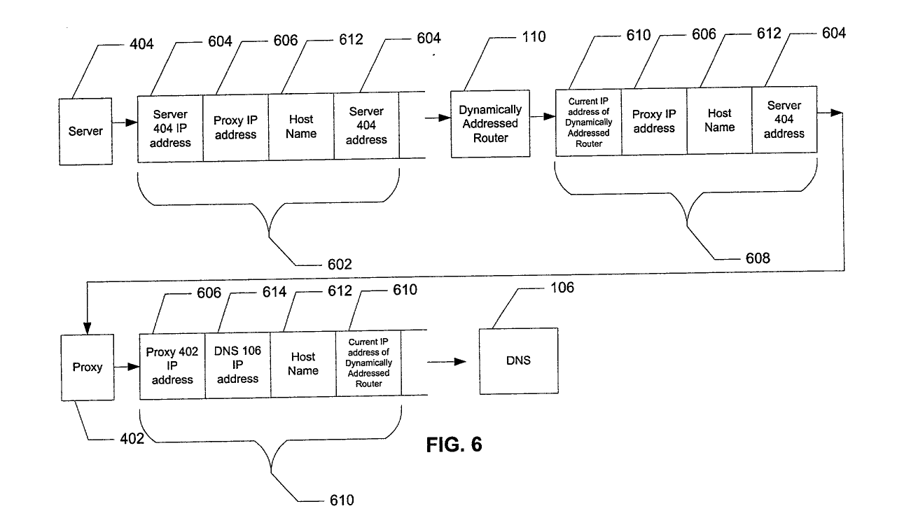

FIGS. 5 and 6, respectively, are a flow chart and a block diagram illustrating a preferred embodiment of a method for maintaining an address for a dynamically addressed router in accordance with the present invention. Referring to both FIGS. 5 and 6, first, the update message generator 406 at a server 404 creates an update message 602, via step 502. In the preferred embodiment, the update message 602 is created at certain time intervals or it can be created when the address of the dynamically addressed router 110 changes. The source Internet protocol (IP) address 604 of the update message 602 is the IP address of the server 404 on which the update message generator 406 resides. The destination IP address 606 is the IP address of the proxy 402. The update message 602 also contains a host name 612 and a host address. In FIG. 6, the host address is the IP address 604 of the server 404. The update message 602 is then sent to the dynamically addressed router 110. The dynamically addressed router 110 translates the source IP address 604 of the update message 602 to the current IP address 610 of the dynamically addressed router 110, via step 504. The update message 608 is then sent to the proxy 402, via step 506. Once received by the proxy 402, the proxy 402 updates the IP address of the dynamically addressed router 110 stored in the DNS 106 with the source IP address 610 of the update message 608, via step 508. In performing the update, the proxy 402 changes the source IP address to the IP address 606 of the proxy 402, the destination IP address to the IP address 614 of the DNS 106, and the host address to the current IP address 610 of the dynamically addressed router 110. The update message 610 is then sent to the DNS 106. In this manner, a current address of a dynamically addressed router 110 is maintained.

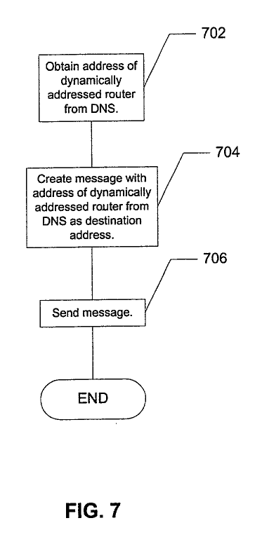

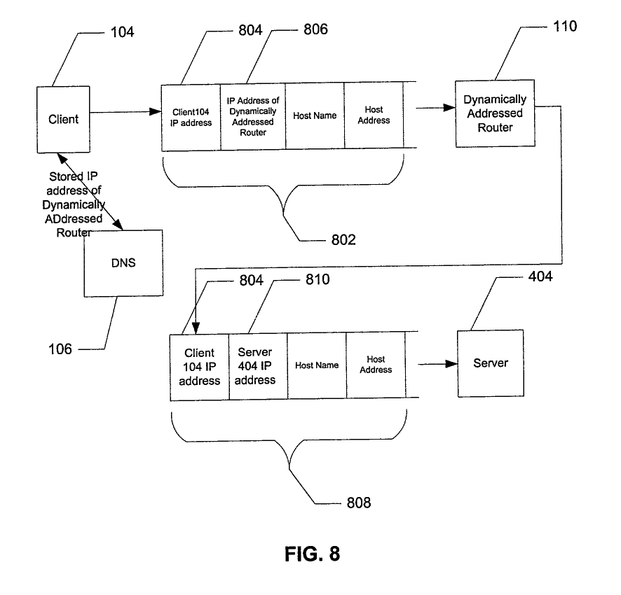

FIGS. 7 and 8, respectively, are a flow chart and a block diagram illustrating an addressing of a message to a dynamically addressed router in accordance with the present invention. Referring to both FIGS. 7 and 8, when a component not connected to the dynamically addressed router 110, such as client 104, wishes to send a message to a server connected to the dynamically addressed router 110, such as server 404, the client 104 first obtains the IP address of the dynamically addressed router 110 from the DNS 106, via step 702. The message 802 is then created with the IP address of the dynamically addressed router 110 from the DNS 106 as the destination IP address 806, via step 704. The IP address of the client 104 is the source IP address 804 of the message 802. The message 802 is then sent, via step 706, to the dynamically addressed router 110. Because the DNS 106 maintains the current IP address of the dynamically addressed router 110, the message 802 properly reaches the dynamically addressed router 110. The dynamically addressed router 110 then translates the destination IP address 806 to the IP address 810 of the server 404, and sends the message 808 to the server 404.

A method and system for maintaining a current address for a dynamically addressed router has been disclosed. The method and system in accordance with the present invention includes a proxy residing at the DNS and an update message generator residing at each server connected to the dynamically addressed router. At certain time intervals, and/or when the address of the dynamically addressed router changes, the update message generator sends an update message to the proxy. The update message contains the current Internet protocol (IP) address of the dynamically addressed router as its source IP address. The proxy updates the IP address of the dynamically addressed router stored on the DNS with the source IP address of the update message. When a component not connected to the dynamically addressed router creates a message intended for the server connected to the dynamically addressed router, the component uses the IP address of the dynamically addressed router stored on the DNS as the destination IP address. In this manner, components not connected to the dynamically addressed router are able to reliably complete the transmission of messages to components connected to the dynamically addressed router.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for maintaining an address of a dynamically addressed router in a network, the network including a server connected to the dynamically addressed router and a domain name server (DNS), comprising the steps of:
(a) creating an update message by an update message generator residing on the server, wherein a source address of the update message is an address of the server;
(b) translating the source address of the update message to a current address of the dynamically addressed router;
(c) sending the update message to a proxy residing on the DNS; and
(d) updating by the proxy an address of the dynamically addressed router stored in the DNS with the source address of the update message.

2. The method of claim 1, wherein the updating step (d) comprises:
(d1) changing a host address of the update message to the current address of the dynamically addressed router; and
(d2) sending the update message to the DNS.

3. The method of claim 1, further comprising:
(e) obtaining the address of the dynamically addressed router stored in the DNS;
(f) creating a message with the address of the dynamically addressed router stored in the DNS as a destination address of the message; and
(g) sending the message.

4. A method for maintaining an address of a dynamically addressed router in a network, the network including a server connected to the dynamically addressed router and a DNS, comprising the steps of:
(a) creating an update message by an update message generator residing on the server, wherein a source address of the update message is an address of the server;
(b) translating the source address of the update message to a current address of the dynamically addressed router;
(c) sending the update message to a proxy residing on the DNS; and
(d) updating by the proxy an address of the dynamically addressed router stored in the DNS with the source address of the update message, wherein the updating comprises the steps of:
(d1) changing a host address of the update message to the current address of the dynamically addressed router; and
(d2) sending the update message to the DNS.

5. A system, comprising:
a server, wherein the server comprises an update message generator;
a dynamically addressed router coupled to the server, wherein the dynamically addressed router translates the source address of the update message to a current address of the dynamically addressed router; and
a DNS, wherein the DNS comprises a proxy, wherein the proxy maintains a current address of the dynamically addressed router utilizing the source address of the update message.

6. The system of claim 5, wherein the update message generator creates an update message at a predetermined time interval, wherein a source address of the update message is an address of the server.

7. The system of claim 5, wherein the update message generator creates an update message when an address of the dynamically addressed router changes.

8. The system of claim 5, wherein the proxy receives the update message from the dynamically addressed router and updates an address of the dynamically addressed router stored in the DNS with the source address of the update message.

9. The system of claim 8, wherein in updating the address of the dynamically addressed router, the proxy changes a host address of the update message to the current address of the dynamically addressed router; and sends the update message to the DNS.

10. A system, comprising:
a server, wherein the server comprises an update message generator, wherein the update message generator creates an update message at a predetermined time interval, wherein a source address of the update message is an address of the server;
a dynamically addressed router coupled to the server, wherein the dynamically addressed router translates the source address of the update message to a current address of the dynamically addressed router; and
a DNS, wherein the DNS comprises a proxy, wherein the proxy receives the update message from the dynamically addressed router and updates an address of the dynamically addressed router stored in the DNS with the source address of the update message.

11. A system for maintaining an address of a dynamically addressed router in a network, the network including a server connected to the dynamically addressed router and a domain name server (DNS), comprising:
means for creating an update message by an update message generator residing on the server, wherein a source address of the update message is an address of the server;
means for translating the source address of the update message to a current address of the dynamically addressed router and for sending the update message to a proxy residing on the DNS; and
means for updating an address of the dynamically addressed router stored in the DNS with the source address of the update message.

12. A computer readable medium with program instructions for maintaining an address of a dynamically addressed router in a network, the network including a server connected to the dynamically addressed router and a domain name server (DNS), the instructions for:
(a) creating an update message by an update message generator residing on the server, wherein a source address of the update message is an address of the server;
(b) translating the source address of the update message to a current address of the dynamically addressed router;
(c) sending the update message to a proxy residing on the DNS; and
(d) updating by the proxy an address of the dynamically addressed router stored in the DNS with the source address of the update message.

13. A computer readable medium with program instructions for maintaining an address of a dynamically addressed router in a network, the network including a server connected to the dynamically addressed router and a domain name server (DNS), the instructions for:
(a) creating an update message by an update message generator residing on the server, wherein a source address of the update message is an address of the server;
(b) translating the source address of the update message to a current address of the dynamically addressed router;
(c) sending the update message to a proxy residing on the DNS;
(d) updating by the proxy an address of the dynamically addressed router stored in the DNS with the source address of the update message, wherein the updating comprises the instructions for:
(d1) changing a host address of the update message to the current address of the dynamically addressed router; and
(d2) sending the update message to the DNS.
